(19) United States
(12) Patent Application Publication
(10) Pub. No.: US 2025/0096764 A1
(43) Pub. Date: Mar. 20, 2025

(54) OPTIMAL DESIGN METHOD AND DEVICE FOR BULK ACOUSTIC RESONATOR, AND STORAGE MEDIUM

(71) Applicant: SOUTH CHINA UNIVERSITY OF TECHNOLOGY, Guangzhou (CN)

(72) Inventors: Guoqiang LI, Guangzhou (CN); Han HU, Guangzhou (CN); Chenyang LI, Guangzhou (CN); Tianyou LUO, Guangzhou (CN); Peidong OUYANG, Guangzhou (CN)

(73) Assignee: SOUTH CHINA UNIVERSITY OF TECHNOLOGY, Guangzhou (CN)

(21) Appl. No.: 18/580,179

(22) PCT Filed: Oct. 31, 2023
(86) PCT No.: PCT/CN2023/128420

§ 371 Date: Jan. 18, 2024

(30) Foreign Application Priority Data
Apr. 6, 2023 (CN) 2023103611538

(51) Int. Cl. H03H 3/02; G06F 30/22; G06F 111/04

(52) U.S. Cl. CPC H03H 3/02; G06F 30/22; G06F 2111/04; H03H 2003/028

(57) ABSTRACT

A Kriging model-based optimal design method and device for a bulk acoustic resonator, and a storage medium are provided. The Kriging model-based optimal design method includes: determining a structure and a material of a resonator, establishing a corresponding MASON model, and performing one-dimensional simulation on the MASON model to obtain a simulation result; determining, based on the simulation result, a design variable for optimizing the resonator, and constructing a Kriging surrogate model; determining an optimization goal, constructing an optimization problem model based on the optimization goal and the Kriging surrogate model, and solving the optimization problem model to obtain an optimal solution; and reducing upper and lower limits of the design variable to improve optimization accuracy. The Kriging model-based optimal design method can predict a performance indicator of an unknown region based on a data characteristic of an existing variable, thereby saving a time cost of actually preparing a device.

### CROSS REFERENCE TO THE RELATED APPLICATIONS

This application is the national phase entry of International Application No. PCT/CN2023/128420, filed on Oct. 31, 2023, which is based upon and claims priority to Chinese Patent Application No. 202310361153.8, filed on Apr. 6, 2023, the entire contents of which are incorporated herein by reference.

### TECHNICAL FIELD

The present disclosure relates to the field of semiconductor materials and devices, and in particular to a Kriging model-based optimal design method and device for a bulk acoustic resonator, and a storage medium.

### BACKGROUND

In recent years, since a film bulk acoustic resonator (FBAR) has advantages of high frequency, miniaturization, high performance, a low power consumption and a high power capacity, and its manufacturing process is compatible with a manufacturing process of an integrated circuit (IC), the FBAR can be integrated to reduce a power consumption and a size of a device, and has become an only integrated radio frequency (RF) front-end filter. Therefore, the FBAR filter will become a core component of 5G high-frequency communication in the future.

The FBAR is mainly constituted by three parts: a substrate, an acoustic wave reflective layer, and a sandwich piezoelectric oscillating stack composed of upper and lower electrodes and a piezoelectric film sandwiched between the upper and lower electrodes. When an RF voltage is applied between the two electrodes, an alternating electric field is generated inside the piezoelectric oscillating stack. Based on an inverse piezoelectric effect of the piezoelectric film, some electrical energy is converted into a bulk acoustic wave that is propagated along a thickness direction of the piezoelectric film and reflected back and forth between the two electrodes. When the bulk acoustic wave is exactly propagated in the piezoelectric oscillating stack at half a wavelength or an odd multiple of half a wavelength, resonance occurs. In other words, a fundamental frequency wavelength of the resonance is approximately equal to twice a thickness of the piezoelectric oscillating stack.

A commonly used simulation design method is to use an advanced design system (ADS) to perform component splitting, attribute definition, and post-combination calculation on its MASON model. When a large amount of data is involved and an optimal value needs to be solved, optimal calculation of the prior art has low efficiency, and often requires manual analysis and solving, which is difficult and time-consuming.

### SUMMARY

In order to resolve one of the technical problems in the prior art to at least a certain extent, the present disclosure is intended to provide a Kriging model-based optimal design method and device for a bulk acoustic resonator, and a storage medium.

The present disclosure adopts following technical solutions.

A Kriging model-based optimal design method for a bulk acoustic resonator includes the following steps:
determining a structure and a material of a resonator, establishing a corresponding MASON model, and performing one-dimensional simulation on the MASON model to obtain a simulation result;
determining, based on the simulation result, a design variable for optimizing the resonator, and constructing a Kriging surrogate model;
determining an optimization goal, constructing an optimization problem model based on the optimization goal and the Kriging surrogate model, and solving the optimization problem model to obtain an optimal solution; and
reducing upper and lower limits of the design variable to improve optimization accuracy.

Further, the resonator structurally includes a bottom electrode, a piezoelectric layer, and a top electrode; and
the piezoelectric layer is made from any one of single crystal aluminum nitride, polycrystalline aluminum nitride, zinc oxide, or lead zirconate titanate, and the top electrode and the bottom electrode are made from any one or a combination of Pt, Mo, W, Ti, or Au.

Further, the step of determining, based on the simulation result, the design variable for optimizing the resonator, and constructing the Kriging surrogate model includes:
taking a material thickness H and an effective resonance area A as design variables for optimizing the resonator, and keeping a series resonance frequency unchanged;
determining a size range of the design variable based on an intercorrelation between a process requirement and a structural size of the resonator;
obtaining sample points through random sampling within the size range of the design variable by using a Latin hypercube experimental design method;
parameterizing the structural size based on the MASON model of the resonator to obtain all models corresponding to the sample points;
after completing parametric modeling, performing simulation calculation on all the sample points to obtain simulation response values of the sample points, where the simulation response values includes series resonance frequency and impedance Z1, parallel resonance frequency and impedance Z2, a quality factor Q, and an effective electromechanical coupling coefficient K, where each set of the H and the A corresponds to one set of the Z1, the Z2, the Q, and the K, an objective function is y=Q*K, and a constraint function is the series resonance frequency and impedance Z1, the parallel resonance frequency and impedance Z2, and corresponding frequencies; and
establishing three Kriging surrogate models for the Q, the K, and the y based on one or two key research points and respective response values Q and K in the sample points H and A.

Further, the step of determining the size range of the design variable includes:
obtaining a boundary value of a size based on the size range, performing simulation calculation, analyzing a calculation result, and determining whether the size range is reasonable; and
if resonance impedance does not meet a requirement, narrowing the size range, and re-determining the size range of the design variable to ensure rationality of the size range.

Further, the optimization goal is to achieve a best electromechanical coupling coefficient and a highest quality factor under a premise that a resonance frequency meets a preset condition; and
an expression of the optimization problem model is as follows:

$$\{ \begin{matrix}Max ( y ( H , A ) ) \\ s . t . \{ \begin{matrix}y ( H , A ) = k * Q \\ H ∈ [ {H}_{L} , {H}_{U} ] \\ A ∈ [ {A}_{L} , {A}_{U} ]\end{matrix}\end{matrix}$$

where Max(y(H,A)) represents that the optimization goal is a figure of merit (FOM), H and A represents the design variables, H_{L} and H_{U} represent lower and upper limits of a thickness value of the design variable, and A_{L} and A_{U} represent lower and upper limits of an area value of the design variable.

Further, the step of reducing the upper and lower limits of the design variable to improve optimization accuracy includes:
narrowing a variable range by using a method including dichotomy, to obtain an optimal structural parameter of the resonator that meets a manufacturing requirement.

Further, the resonator further includes a functional layer and a substrate, and the functional layer includes a load layer above the top electrode, a temperature compensation layer above the piezoelectric layer, a support layer above the substrate, a seed layer above the bottom electrode, and a Bragg reflective layer below the bottom electrode.

Further, the resonator has any one of a bulk silicon back-etching structure, a solid-state assembly structure, or a cavity structure.

Further, any combination or variant of the material layer thickness and the area can be selected for variable research.

Another technical solution adopted in the present disclosure is as follows:

A Kriging model-based optimal design device for a bulk acoustic resonator includes:
at least one processor, and
at least one memory configured to store at least one program;
where the at least one program is executed by the at least one processor to execute the above method.

Another technical solution adopted in the present disclosure is as follows:

A computer-readable storage medium stores a program that is executable by a processor, where the program that is executable by the processor is executed by the processor to execute the above method.

The present disclosure has following beneficial effects: The present disclosure can predict a performance indicator of an unknown region based on a data characteristic of an existing variable, thereby saving a time cost of actually preparing a device and effectively shortening calculation time and a labor cost compared with a complex simulation operation that often takes a plurality of days.

### BRIEF DESCRIPTION OF THE DRAWINGS

To describe the technical solutions in the embodiments of the present disclosure or in the prior art more clearly, the following describes the accompanying drawings for the technical solutions in the embodiments of the present disclosure or in the prior art. It should be understood that the accompanying drawings in the following description are only used to clearly express some embodiments in the technical solutions of the present disclosure, and those skilled in the art may further derive other accompanying drawings based on these drawings without creative efforts.

FIG. 1 is a flowchart of a Kriging model-based optimal design method for a bulk acoustic resonator according to an embodiment of the present disclosure;

FIG. 2 shows an output impedance characteristic curve according to an embodiment of the present disclosure;

FIG. 3 is an actual (predicted) graph showing a relationship among a ratio of a thickness of a top electrode to a thickness of a bottom electrode, the thickness of the bottom electrode, and an effective electromechanical coupling coefficient of an initially optimized Kriging model according to an embodiment of the present disclosure; and

FIG. 4 is an actual (predicted) graph showing a relationship among a ratio of a thickness of a top electrode to a thickness of a bottom electrode, the thickness of the bottom electrode, and an effective electromechanical coupling coefficient of an optimized Kriging model according to an embodiment of the present disclosure.

### DETAILED DESCRIPTION OF THE EMBODIMENTS

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary. These embodiments are merely used to explain the present disclosure, and should not be construed as a limitation to the present disclosure. The step number in the following embodiments is only for convenience of explanation. The present disclosure does not limit the sequence between steps, and the execution sequence of each step in the embodiments can be adjusted adaptively according to the understanding of those skilled in the art.

In the description of the present disclosure, it should be understood that, in orientation description, orientation or position relationships indicated by terms such as “upper”, “lower”, “front”, “rear”, “left”, and “right” are orientation or position relationships as shown in the accompanying drawings. These terms are merely intended to facilitate and simplify the description of the present disclosure, rather than to indicate or imply that the mentioned device or components must have a specific orientation or must be constructed and operated in a specific orientation. Therefore, these terms should not be understood as a limitation to the present disclosure.

In the description of the present disclosure, “some” means at least one, while “a plurality of” means a number larger than two; “greater than”, “less than”, “over” and the like are construed as not including the number, and “above”, “below”, “within” and the like are construed as including the number. The “first” and “second” in the description are merely intended to distinguish technical features, rather than to indicate or imply relative importance or implicitly indicate a quantity of the indicated technical features or implicitly indicate a sequence relationship of the indicated technical features.

In the description of the present disclosure, unless otherwise explicitly defined, the words such as “dispose”, “install” and “connect” should be understood in a broad sense, and those skilled in the technical field can reasonably determine the specific meanings of the above words in the present disclosure in combination with specific contents of the technical solutions.

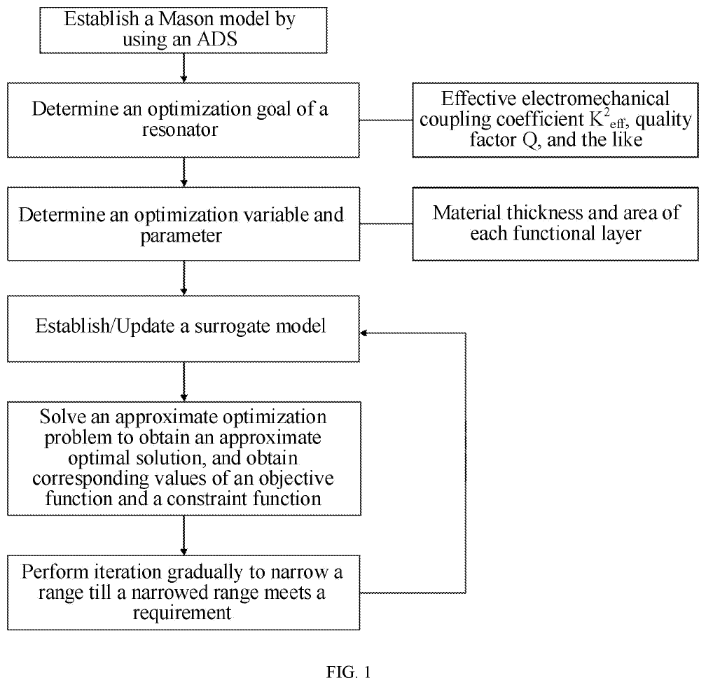

In order to resolve problems of low computational efficiency and inability to quickly and accurately find an optimal solution in the prior art, as shown in FIG. 1, an embodiment provides a Kriging model-based optimal design method for a bulk acoustic resonator. The Kriging model-based optimal design method is efficient and can perform optimization quickly and accurately. The Kriging model-based optimal design method specifically includes the following steps.

S1: A structure and a material of a resonator are determined, a corresponding MASON model is established, and one-dimensional simulation is performed on the MASON model to obtain a simulation result.

In this embodiment, a basic structure of the resonator includes a bottom electrode, a piezoelectric layer, and a top electrode. As an optional implementation, a support layer, a load layer, a protective layer, and other structures can be added as needed. The corresponding MASON model is established based on the structure of the resonator. The MASON model is simulated and solved to obtain an impact of each parameter on performance.

S2: A design variable for optimizing the resonator is determined based on the simulation result, and a Kriging surrogate model is constructed.

Based on the analysis result of the one-dimensional simulation obtained in the step S1, it can be seen that, with the material unchanged, main factors affecting a resonance frequency, a quality factor, and an effective electromechanical coupling coefficient of a device are geometric parameters such as a thickness and area of each functional layer of the material. Therefore, material thickness H and effective resonance area A are selected as design variables for optimizing the resonator, and a series resonance frequency keeps unchanged. Then, a size range of the design variable is preliminarily determined based on an intercorrelation between a process requirement and a structural size of the resonator. Based on the preliminarily determined size range, a boundary value of a size is selected to perform simulation calculation, a calculation result is analyzed, and whether the size range is reasonable is determined. If resonance impedance does not meet a requirement, the size range is narrowed, and size ranges of four design variables are re-determined to ensure their rationality.

Random sampling is performed within the size range of the design variable by using an optimal Latin hypercube experimental design method, to obtain uniform and sufficient sample points. The MASON model of the resonator is established, and four structural sizes are parameterized to obtain all models corresponding to the sample points. After parametric modeling is completed, simulation calculation is performed on all the sample points according to the simulation method determined in the step S1 to obtain simulation response values of the sample points: series resonance frequency and impedance Z1, parallel resonance frequency and impedance Z2, quality factor Q, and effective electromechanical coupling coefficient K. So far, each set of the H and the A corresponds to one set of the Z1, the Z2, the Q, and the K, objective function is y=Q*K, and a constraint function is the series resonance frequency and impedance Z1, the parallel resonance frequency and impedance Z2, and corresponding frequencies.

Three Kriging surrogate models for the Q, the K, and the y are established based on one to two key research points and respective response values Q and K in the sample points H and A.

S3: An optimization goal is determined, and an optimization problem model is established based on the optimization goal and the Kriging surrogate model, and is solved to obtain an optimal solution.

An ultimate optimization goal is to achieve a best electromechanical coupling coefficient and a highest quality factor under a premise that the resonance frequency is satisfied. Therefore, an evaluation index, namely a FOM, is introduced. A final optimization problem model is established as follows:

$$\{ \begin{matrix}Max ( y ( H , A ) ) \\ s . t . \{ \begin{matrix}y ( H , A ) = k * Q \\ H ∈ [ {H}_{L} , {H}_{U} ] \\ A ∈ [ {A}_{L} , {A}_{U} ]\end{matrix}\end{matrix}$$

In the above model, Max(y(H,A)) represents that the optimization goal is the FOM, namely objective function maximization; H and A represents the design variables, H_{L} and H_{U} represent lower and upper limits of a thickness value of the design variable, and A_{L} and A_{U} represent lower and upper limits of an area value of the design variable.

S4: Upper and lower limits of the design variable are reduced to improve optimization accuracy.

A better structural parameter of the resonator is obtained through the optimization in the step S3. A variable range is narrowed for a plurality of times by using a method including dichotomy, to obtain an optimal structural parameter of the resonator that meets a manufacturing requirement.

The Kriging model-based optimal design method is described in detail below with reference to the accompanying drawings and specific embodiments.

Referring to FIG. 1, an embodiment provides a Kriging model-based optimal design method for a bulk acoustic resonator, including the following steps:

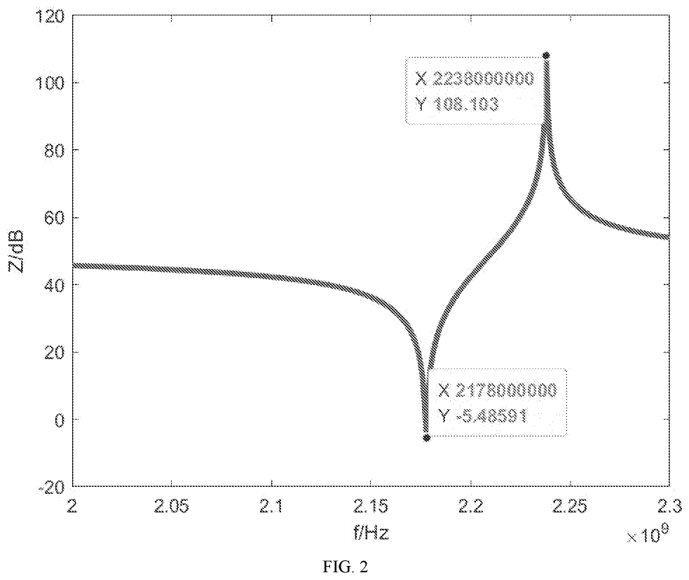

Step 1: A structure and a material of a resonator are determined, a corresponding MASON model is established, one-dimensional simulation is performed, and a simulation result is analyzed.
1.1) A basic structure of the resonator includes a bottom electrode, a piezoelectric layer, and a top electrode.
1.2) The MASON model of the resonator is simulated and solved to preliminarily obtain an impedance characteristic curve shown in FIG. 2.

Step 2: Ratio r of a thickness of the top electrode to a thickness of the bottom electrode, the thickness H of the bottom electrode, and their size ranges are determined as design variables. Parametric modeling is performed to obtain a response value of a sample point, and a Kriging surrogate model is constructed.
2.1) The piezoelectric layer is fixed at 1100 nm, and opposite area of the electrode is 7000 μm². AIN is selected as a material of the piezoelectric layer, and it is defined that a clamping dielectric constant is 9.5*10⁻¹¹ F/m, acoustic impedance is 3.7*10⁷ kg/m²s, an acoustic velocity of an electrode layer is 11350 m/s, an electromechanical coupling coefficient is 6%, and an attenuation factor is 800 dB/m. Mo is selected as an electrode material, and it is defined that the acoustic impedance is 6.39*10⁷ kg/m²s, the acoustic velocity of the electrode layer is 6213 m/s, and the attenuation factor is 500 dB/m. Then, based on an intercorrelation between a process requirement and a structural size of the resonator, the size range of the ratio of the thickness of the top electrode to the thickness of the bottom electrode is preliminarily determined as (0, 1.2), and the size range of the thickness of the bottom electrode is preliminarily determined as (0, 300) nm.
2.2) 100 sample points are randomly sampled within a size range of the design variable by using an optimal Latin hypercube experimental design method, to obtain uniform and sufficient sample points. The MASON model of the resonator is established. Parameters of the sample points are substituted into the model for calculation to obtain simulation result response values: series resonance frequency and impedance Z1, parallel resonance frequency and impedance Z2, quality factor Q, and effective electromechanical coupling coefficient K. So far, each set of the H and the r corresponds to one set of the Z1, the Z2, and the K, the effective electromechanical coupling coefficient K of the objective function, and a constraint function is the series resonance frequency and impedance Z1, the parallel resonance frequency and impedance Z2, and corresponding frequencies.
2.3) A Kriging surrogate model for the K is established based on the sample points H and r and the response values Q thereof.

Step 3: An optimization problem model is established to obtain an optimal solution.

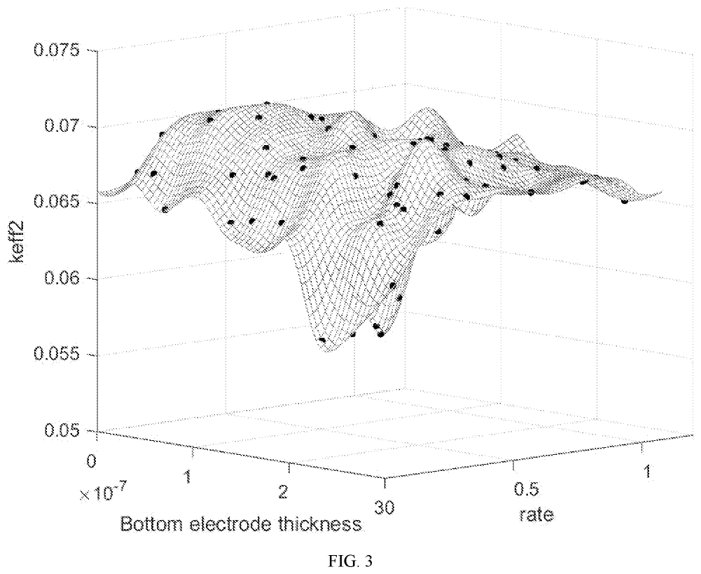

An ultimate optimization goal is to achieve a best electromechanical coupling coefficient under a premise that a resonance frequency is met. Based on this, the Kriging model is calculated, and a result is obtained, as shown in FIG. 3.

Step 4: Upper and lower limits of the design variable are reduced to improve optimization accuracy.

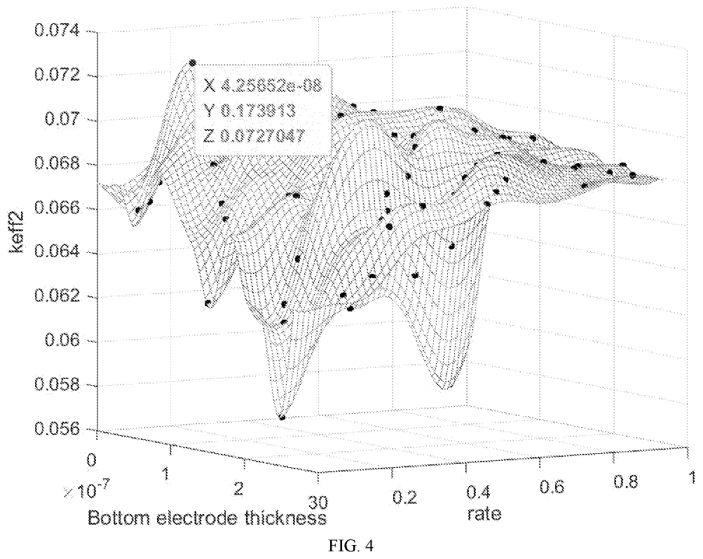

Better structural parameters of the resonator are obtained through the optimization in the previous step within less than 1 minute. In a conventional method, it will take a plurality of days for engineers to modify parameter simulation results one by one in ADS software, and it is not necessarily possible to find a local optimal solution. In contrast, the method in the present disclosure has higher accuracy and lower spatial complexity. A variable range is narrowed for a plurality of times to obtain optimal structural parameters that are of the resonator and meet a manufacturing requirement. As shown in FIG. 4, an optimal ratio of the thickness of the top electrode to the thickness of the bottom electrode is 0.173913, an optimal thickness of the bottom electrode is 42.5652 nm, and a corresponding maximum effective electromechanical coupling coefficient is 7.27%.

In conclusion, compared with the prior art, the method in the present disclosure at least has following advantages and beneficial effects:
(1) The method in the present disclosure can use an algorithm to represent a relationship between an indicator variable of a design requirement and an objective function, and therefore, can predict a performance indicator of an unknown region based on a data characteristic of an existing variable, thereby saving a time cost of actually preparing a device.
(2) A surrogate model used in the present disclosure is very portable, and uses a “black box” to replace a traditional simulation calculation process. This effectively shortens calculation time compared with a complex simulation operation that takes a plurality of days.
(3) The surrogate model in the present disclosure can be constructed only by extracting a parameter of a device under study. Through an operation of the surrogate model, a coupling relationship between various types of parameters can be intuitively found, which is beneficial for further understanding the coupling relationship between the various types of parameters of the device.
(4) The method of using the surrogate model has a wide range of applications, and is highly adaptive to a discrete variable while handling continuous variables, which makes it ideal for modeling and computing an FBAR.

The embodiments further provide a Kriging model-based optimal design device for a bulk acoustic resonator, including:
at least one processor, and
at least one memory configured to store at least one program.

The at least one program is executed by the at least one processor to implement the method shown in FIG. 1.

The Kriging model-based optimal design device for a bulk acoustic resonator in this embodiment can execute the Kriging model-based optimal design method for a bulk acoustic resonator according to the embodiments of the present disclosure, can perform any combination of implementation steps of the method embodiment, and has corresponding functions and beneficial effects of the method.

The embodiments of the present disclosure further provide a computer program product or a computer program. The computer program product or the computer program includes a computer instruction. The computer instruction is stored in a computer-readable storage medium. A processor of a computer device can read the computer instruction from the computer-readable storage medium, and executes the computer instruction to enable the computer device to execute the method shown in FIG. 1.

The embodiments further provide a storage medium. The storage medium stores an instruction or a program that can execute the Kriging model-based optimal design method for a bulk acoustic resonator according to the embodiments of the present disclosure. The instruction or the program can be run to perform any combination of implementation steps of the method embodiment, and has corresponding functions and beneficial effects of the method.

In some optional embodiments, functions/operations mentioned in a block diagram may not occur in an order mentioned in an operation diagram. For example, functions/operations in two consecutively shown blocks may actually be executed substantially concurrently, or sometimes may be executed in a reverse order. In addition, the embodiments presented and described in the flowcharts of the present disclosure are provided by way of example, to provide a more comprehensive understanding of the technology. The disclosed method is not limited to the operations and logical processes presented herein. Optional embodiments are contemplated. In these embodiments, an order of various operations is altered and some sub-operations of a large operation are performed independently.

Furthermore, although the present disclosure is described in the context of functional modules, it should be understood that, unless otherwise indicated to the contrary, one or more of the described functions and/or features may be integrated into a single physical device and/or software module, or may be implemented in separate physical devices or software modules. It can be also understood that a detailed discussion on actual implementation of each module is not necessary for understanding of the present disclosure. More precisely, considering attributes, functions, and internal relationships of various functional modules in the device disclosed in this specification, engineers will understand actual implementation of the modules within their conventional techniques. Therefore, those skilled in the art can implement the present disclosure described in the claims without excessive experimentation by using ordinary techniques. It can be also understood that the disclosed specific concepts are merely illustrative and are not intended to limit the scope of the present disclosure, which is determined by the full scope of the appended claims and their equivalents.

If implemented in a form of a software functional unit and sold or used as a standalone product, functions may be stored in a computer-readable storage medium. Based on such understanding, the technical solutions of the present disclosure essentially or the part contributing to the prior art or part of the technical solution may be implemented in a form of a software product. The computer software product is stored in a storage medium, and includes several instructions for enabling a computer device (which may be a personal computer, a server, a network device, or the like) to perform all or some steps of the method according to each of the embodiments of the present disclosure. The foregoing storage medium includes any medium that can store a program code, such as a universal serial bus (USB) flash disk, a mobile hard disk, a read-only memory (ROM), a random access memory (RAM), a magnetic disk, or an optical disk.

The logic and/or steps represented in the flowchart or described in other manners herein, for example, may be considered as a sequenced list of executable instructions for implementing logical functions, and may be specifically implemented in any computer-readable medium, for use by instruction execution systems, apparatuses, or devices (such as computer-based systems, systems including processors, or other systems that can fetch instructions from the instruction execution systems, apparatuses, or devices and execute the instructions), or used in combination with these instruction execution systems, apparatuses, or devices. For the purposes of this specification, the “computer-readable medium” may be any apparatus that can contain, store, communicate, propagate, or transmit a program for use by the instruction execution systems, apparatuses, or devices or in combination with these instruction execution systems, apparatuses, or devices.

More specific examples (this list is not exhaustive) of the computer-readable medium include the following: an electrical connection portion (an electrical apparatus) with one or more buses, a portable computer cartridge (a magnetic apparatus), a RAM, a ROM, an electrically erasable programmable read-only memory (EPROM or flash memory), an optical fiber apparatus, and a compact disc read-only memory (CDROM). In addition, the computer-readable medium may even be a piece of paper on which the program can be printed or another appropriate medium, because, for example, optical scanning may be performed on the paper or the another medium, then processing, such as edition, decoding, or another appropriate means when necessary, may be performed to obtain the program in an electronic manner, and then the program is stored in a computer storage.

It should be understood that the present disclosure may be implemented by using hardware, software, firmware, or a combination thereof. In the above implementations, a plurality of steps or methods may be implemented by using software or firmware that is stored in a memory and that is executed by a proper instruction execution system. For example, if implemented by using hardware, as in another implementation, this implementation may be implemented by any one or a combination of the following technologies known in the art: a discrete logic circuit with a logic gate circuit for implementing a logic function on a data signal, an application-specific integrated circuit with a suitable combinational logic gate circuit, a programmable gate array (PGA), a field programmable gate array (FPGA), and the like.

In the description of this specification, the description referring to terms such as “an implementation/embodiment”, “another implementation/embodiment”, and “some implementations/embodiments” means that the specific feature, structure, material, or characteristic described in combination with the implementation(s) or example(s) is included in at least one implementation or example of the present disclosure. In this specification, the schematic expression of the above terms does not necessarily refer to the same implementation or example. Moreover, the described specific feature, structure, material, or characteristic may be combined in an appropriate manner in any one or more implementations or examples.

Although the implementations of the present disclosure are illustrated and described, it should be understood that those of ordinary skill in the art may still make various changes, modifications, replacements, and variations to these implementations without departing from the principle and spirit of the present disclosure, and the scope of the present disclosure is limited by the claims and equivalents thereof.

The preferred embodiments of the present disclosure have been described in detail above, but the present disclosure is not limited to these embodiments. Those skilled in the art may make various equivalent modifications or substitutions without departing from the spirit of the present disclosure, and these equivalent modifications or substitutions are all included in the scope defined by the claims of the present disclosure.

What is claimed is:

1. A Kriging model-based optimal design method for a bulk acoustic resonator, comprising the following steps:
determining a structure and a material of a resonator, establishing a corresponding MASON model, and performing one-dimensional simulation on the MASON model to obtain a simulation result;
determining, based on the simulation result, a design variable for optimizing the resonator, and constructing a Kriging surrogate model;
determining an optimization goal, constructing an optimization problem model based on the optimization goal and the Kriging surrogate model, and solving the optimization problem model to obtain an optimal solution; and
reducing upper and lower limits of the design variable to improve optimization accuracy.

2. The Kriging model-based optimal design method for the bulk acoustic resonator according to claim 1, wherein the resonator comprises a bottom electrode, a piezoelectric layer, and a top electrode; and
the piezoelectric layer is made from any one of single crystal aluminum nitride, polycrystalline aluminum nitride, zinc oxide, or lead zirconate titanate, and the top electrode and the bottom electrode are made from any one or a combination of Pt, Mo, W, Ti, or Au.

3. The Kriging model-based optimal design method for the bulk acoustic resonator according to claim 1, wherein the step of determining, based on the simulation result, the design variable for optimizing the resonator, and constructing the Kriging surrogate model comprises:
taking a material thickness H and an effective resonance area A as design variables for optimizing the resonator;
determining a size range of the design variable based on an intercorrelation between a process requirement and a structural size of the resonator;
obtaining sample points through random sampling within the size range of the design variable by using a Latin hypercube experimental design method;
parameterizing the structural size based on the MASON model of the resonator to obtain all models corresponding to the sample points;
after completing parametric modeling, performing simulation calculation on all the sample points to obtain simulation response values of the sample points, wherein the simulation response values comprise series resonance frequency and impedance Z1, parallel resonance frequency and impedance Z2, a quality factor Q, and an effective electromechanical coupling coefficient K, wherein each set of the H and the A corresponds to one set of the Z1, the Z2, the Q, and the K, an objective function is y=Q*K, and a constraint function is the series resonance frequency and impedance Z1, the parallel resonance frequency and impedance Z2, and corresponding frequencies; and
establishing three Kriging surrogate models for the Q, the K, and the y based on one or two key research points and respective response values Q and K in the sample points H and A.

4. The Kriging model-based optimal design method for the bulk acoustic resonator according to claim 3, wherein the step of determining the size range of the design variable comprises:
obtaining a boundary value of a size based on the size range, performing simulation calculation, analyzing a calculation result, and determining whether the size range is reasonable; and
when resonance impedance does not meet a requirement, narrowing the size range, and re-determining the size range of the design variable to ensure rationality of the size range.

5. The Kriging model-based optimal design method for the bulk acoustic resonator according to claim 3, wherein the optimization goal is to achieve a best electromechanical coupling coefficient and a highest quality factor under a premise that a resonance frequency meets a preset condition; and
an expression of the optimization problem model is as follows:
$$\{ \begin{matrix}Max ( y ( H , A ) ) \\ s . t . \{ \begin{matrix}y ( H , A ) = k * Q \\ H ∈ [ {H}_{L} , {H}_{U} ] \\ A ∈ [ {A}_{L} , {A}_{U} ]\end{matrix}\end{matrix}$$
wherein Max(y(H,A)) represents that the optimization goal is a figure of merit (FOM), H and A represents the design variables, H_{L} and H_{U} respectively represent lower and upper limits of a thickness value of the design variable, and A_{L} and A_{U} respectively represent lower and upper limits of an area value of the design variable.

6. The Kriging model-based optimal design method for the bulk acoustic resonator according to claim 5, wherein the step of reducing the upper and lower limits of the design variable to improve optimization accuracy comprises:
narrowing a variable range by using a method comprising dichotomy, to obtain an optimal structural parameter of the resonator that meets a manufacturing requirement.

7. The Kriging model-based optimal design method for the bulk acoustic resonator according to claim 2, wherein the resonator further comprises a functional layer and a substrate, wherein the functional layer comprises a load layer above the top electrode, a temperature compensation layer above the piezoelectric layer, a support layer above the substrate, a seed layer above the bottom electrode, and a Bragg reflective layer below the bottom electrode.

8. The Kriging model-based optimal design method for the bulk acoustic resonator according to claim 1, wherein the resonator has any one of a bulk silicon back-etching structure, a solid-state assembly structure, or a cavity structure.

9. A Kriging model-based optimal design device for a bulk acoustic resonator, comprising:
at least one processor, and
at least one memory configured to store at least one program;
wherein the at least one program is executed by the at least one processor to implement the Kriging model-based optimal design method according to claim 1.

10. A computer-readable storage medium, storing a program, wherein the program is executable by a processor, and the program is executed by the processor to execute the Kriging model-based optimal design method according to claim 1.

11. The Kriging model-based optimal design device for the bulk acoustic resonator according to claim 9, wherein the resonator comprises a bottom electrode, a piezoelectric layer, and a top electrode; and
the piezoelectric layer is made from any one of single crystal aluminum nitride, polycrystalline aluminum nitride, zinc oxide, or lead zirconate titanate, and the top electrode and the bottom electrode are made from any one or a combination of Pt, Mo, W, Ti, or Au.

12. The Kriging model-based optimal design device for the bulk acoustic resonator according to claim 9, wherein the step of determining, based on the simulation result, the design variable for optimizing the resonator, and constructing the Kriging surrogate model comprises:
taking a material thickness H and an effective resonance area A as design variables for optimizing the resonator;
determining a size range of the design variable based on an intercorrelation between a process requirement and a structural size of the resonator;
obtaining sample points through random sampling within the size range of the design variable by using a Latin hypercube experimental design method;
parameterizing the structural size based on the MASON model of the resonator to obtain all models corresponding to the sample points;
after completing parametric modeling, performing simulation calculation on all the sample points to obtain simulation response values of the sample points, wherein the simulation response values comprise series resonance frequency and impedance Z1, parallel resonance frequency and impedance Z2, a quality factor Q, and an effective electromechanical coupling coefficient K, wherein each set of the H and the A corresponds to one set of the Z1, the Z2, the Q, and the K, an objective function is y=Q*K, and a constraint function is the series resonance frequency and impedance Z1, the parallel resonance frequency and impedance Z2, and corresponding frequencies; and
establishing three Kriging surrogate models for the Q, the K, and the y based on one or two key research points and respective response values Q and K in the sample points H and A.

13. The Kriging model-based optimal design device for the bulk acoustic resonator according to claim 12, wherein the step of determining the size range of the design variable comprises:
obtaining a boundary value of a size based on the size range, performing simulation calculation, analyzing a calculation result, and determining whether the size range is reasonable; and
when resonance impedance does not meet a requirement, narrowing the size range, and re-determining the size range of the design variable to ensure rationality of the size range.

14. The Kriging model-based optimal design device for the bulk acoustic resonator according to claim 12, wherein the optimization goal is to achieve a best electromechanical coupling coefficient and a highest quality factor under a premise that a resonance frequency meets a preset condition; and
an expression of the optimization problem model is as follows:
$$\{ \begin{matrix}Max ( y ( H , A ) ) \\ s . t . \{ \begin{matrix}y ( H , A ) = k * Q \\ H ∈ [ {H}_{L} , {H}_{U} ] \\ A ∈ [ {A}_{L} , {A}_{U} ]\end{matrix}\end{matrix}$$
wherein Max(y(H,A)) represents that the optimization goal is a figure of merit (FOM), H and A represents the design variables, H_{L} and H_{U} respectively represent lower and upper limits of a thickness value of the design variable, and A_{L} and A_{U} respectively represent lower and upper limits of an area value of the design variable.

15. The Kriging model-based optimal design device for the bulk acoustic resonator according to claim 14, wherein the step of reducing the upper and lower limits of the design variable to improve optimization accuracy comprises:
narrowing a variable range by using a method comprising dichotomy, to obtain an optimal structural parameter of the resonator that meets a manufacturing requirement.

16. The Kriging model-based optimal design device for the bulk acoustic resonator according to claim 11, wherein the resonator further comprises a functional layer and a substrate, wherein the functional layer comprises a load layer above the top electrode, a temperature compensation layer above the piezoelectric layer, a support layer above the substrate, a seed layer above the bottom electrode, and a Bragg reflective layer below the bottom electrode.

17. The Kriging model-based optimal design device for the bulk acoustic resonator according to claim 9, wherein the resonator has any one of a bulk silicon back-etching structure, a solid-state assembly structure, or a cavity structure.

18. The computer-readable storage medium according to claim 10, wherein the resonator comprises a bottom electrode, a piezoelectric layer, and a top electrode; and
the piezoelectric layer is made from any one of single crystal aluminum nitride, polycrystalline aluminum nitride, zinc oxide, or lead zirconate titanate, and the top electrode and the bottom electrode are made from any one or a combination of Pt, Mo, W, Ti, or Au.

19. The computer-readable storage medium according to claim 10, wherein the step of determining, based on the simulation result, the design variable for optimizing the resonator, and constructing the Kriging surrogate model comprises:
taking a material thickness H and an effective resonance area A as design variables for optimizing the resonator;
determining a size range of the design variable based on an intercorrelation between a process requirement and a structural size of the resonator;
obtaining sample points through random sampling within the size range of the design variable by using a Latin hypercube experimental design method;
parameterizing the structural size based on the MASON model of the resonator to obtain all models corresponding to the sample points;
after completing parametric modeling, performing simulation calculation on all the sample points to obtain simulation response values of the sample points, wherein the simulation response values comprise series resonance frequency and impedance Z1, parallel resonance frequency and impedance Z2, a quality factor Q, and an effective electromechanical coupling coefficient K, wherein each set of the H and the A corresponds to one set of the Z1, the Z2, the Q, and the K, an objective function is y=Q*K, and a constraint function is the series resonance frequency and impedance Z1, the parallel resonance frequency and impedance Z2, and corresponding frequencies; and
establishing three Kriging surrogate models for the Q, the K, and the y based on one or two key research points and respective response values Q and K in the sample points H and A.

20. The computer-readable storage medium according to claim 19, wherein the step of determining the size range of the design variable comprises:
obtaining a boundary value of a size based on the size range, performing simulation calculation, analyzing a calculation result, and determining whether the size range is reasonable; and
when resonance impedance does not meet a requirement, narrowing the size range, and re-determining the size range of the design variable to ensure rationality of the size range.
